(19) United States
(12) Patent Application Publication
(10) Pub. No.: US 2026/0217973 A1
(43) Pub. Date: Jul. 30, 2026

(54) COMPOSITION COMPRISING AT LEAST ONE RECYCLED POLYAMIDE OF FORMULA XY OR A/XY

(71) Applicant: ARKEMA FRANCE, COLOMBES (FR)

(72) Inventor: Thomas PRENVEILLE, Serquigny Cerdato (FR)

(73) Assignee: ARKEMA FRANCE, Puteaux (FR)

(21) Appl. No.: 19/147,351

(22) PCT Filed: Jan. 11, 2024
(86) PCT No.: PCT/FR2024/050039

§ 371 Date: Jul. 11, 2025

(30) Foreign Application Priority Data
Jan. 11, 2023 (FR) FR2300268

(51) Int. Cl. C08L 77/02; C08L 77/06

(52) U.S. Cl. CPC C08L 77/02; C08L 77/06; C08L 2205/025; C08L 2207/20

(57) ABSTRACT

The present invention relates to a composition comprising at least:
(a) from 30% to 99.9% by weight of at least one recycled polyamide of formula XY or A/XY,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

It also relates to the use of such a composition for the manufacture of objects, and also to the corresponding objects.

The present patent application relates to a composition comprising at least one recycled polyamide of formula XY or A/XY, as defined according to the invention, and to a process for its manufacture.

It also relates to the use of such a composition for the manufacture of objects, and also to the corresponding objects.

Circular economy makes it possible to limit the production of waste, the exhaustion of the planet's resources and the environmental impact. In this context, it is desired in particular to promote the (energy or material) recovery and in particular the recycling of waste. This makes it possible to thus limit as much as possible the ultimate waste, that is to say the waste which is not capable of being processed under current technical and economic conditions and which will be incinerated or sent to specific storage centers.

The term “energy recovery” is understood to denote the use of waste (oils, tires, plastics, and the like) as means for the production of energy, by direct incineration, with or without other waste.

The term “material recovery” is understood to denote the reuse or the re-employment, that is to say the fresh employment, of a part which retains the same use and is not transformed.

The term “recycling” is understood to denote the operation targeted at introducing the materials originating from waste into the production cycle, in complete or partial replacement of a virgin material.

The present invention relates very particularly to the recycling of waste, and is targeted in particular at providing compositions comprising at least one recycled polyamide of formula XY or A/XY, as defined according to the invention.

There typically exist two types of recycled content: post-industrial (or post-industrial recycled PIR) waste and post-consumer (or post-consumer recycled PCR) waste.

Post-industrial waste (also known as “pre-consumer” waste) refers to the waste generated either by the manufacturing process which resulted in the creation of the original source material (manufacturing process of polymerization and/or compounding type, for example) or by the manufacturing process which resulted, starting in particular from an original source material, in the creation of an object, such as a sports article, an article for a motor vehicle, such as, for example, an airplane, a drone, an aircraft, an electric bicycle, a moped, a motorcycle, a side car, a car, a van, a tractor, a truck, an urban bus, a long-distance bus, a snowmobile, a motor crawler, a bulldozer, a snow groomer and a tank, an electronic article for the general public, a medical article or an industrial article (manufacturing process of injection or extrusion type, for example). Post-industrial waste within the meaning of the invention can thus typically be injection sprues of these various articles or bleed blocks. Within the meaning of the invention, parts which fail to meet the specifications or which exhibit defects of such a nature as to prevent them from being sold are also regarded as post-industrial waste.

Post-consumer waste, for its part, corresponds to articles, such as, for example, those mentioned above, after use by the final consumer or which have reached the end of their life. This is waste which has been used before being discarded, for example which has been used for at least a day, for example at least a week, for example at least a month, for example at least a year, for example several years. This waste is typically collected close to the end users during the discarding thereof, for the purpose of recycling it.

Nowadays, the management of waste (both post-industrial and post-consumer) and also the lifespan of an object are essential for the consumer and have become key requirements, in particular for major sports and electronics brands. This trend increases the advantage of having available compositions containing, at least in part, recycled products.

Also, in the context of sustainable consumption and production modes, the quality of the recycled products used in frequently replaced objects, such as sports articles and electronic articles for the general public, takes on particular importance. In point of fact, for these articles, the requirements in terms of performance are particularly high.

For these reasons, there thus exists a need to have available compositions comprising at least one polyamide of formula XY or A/XY, as defined according to the invention, and exhibiting a much smaller impact with regard to the CO₂ emissions.

There also exists a need for novel compositions comprising at least one recycled polyamide of formula XY or A/XY, as defined according to the invention, and retaining good mechanical properties (for example in terms of impact strength, of low density, of modulus, of stress and of elongation at yield, in particular at high temperature, of stress and of elongation at break, in particular at high temperature, and of ability to adhere to different substrates) and also good processability (suitability for processing, for transformation, in particular by extrusion, by injection, by overmolding or by welding). In particular, there remains a need for compositions exhibiting an improved processability by injection, especially a high flow length in injection.

The objects obtained from the compositions according to the invention advantageously exhibit properties sufficient to make possible their use in high performance applications and not only in lower performance applications, such as in street furniture or roads.

In particular, the compositions according to the invention advantageously exhibit a better processability and in particular an increase in the flow length during injection molding. This improvement makes it possible to inject thinner parts with better definition.

The compositions according to the invention can also make possible better adhesion to other polymers and in particular to polyamides.

The inventors have discovered, surprisingly, that the use of recycled polyamides of formula XY or A/XY as defined below, in compositions according to the invention, makes it possible to meet these needs.

Thus, the invention relates, according to one of its aspects, to a composition comprising at least:
(a) from 30% to 99.9% by weight of at least one recycled polyamide exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
with said polyamide being a polyamide of formula XY or A/XY in which:
   A is an aliphatic repeat unit chosen from a unit obtained from the polycondensation of at least one amino acid, a unit obtained from the polycondensation of at least one lactam and a unit obtained from the polycondensation of at least one aliphatic diamine and of at least one aliphatic diacid,
   X is at least one aliphatic or cycloaliphatic diamine, or one arylaliphatic or aromatic diamine, or a mixture of these, and
   Y is at least one dicarboxylic acid, said diacid being chosen from a linear or branched aliphatic diacid, a cycloaliphatic diacid and an aromatic diacid, or a mixture of these,
said diamine and said diacid comprising from 4 to 48 carbon atoms, advantageously from 6 to 18 carbon atoms,
with at least one of X and/or Y being cycloaliphatic, arylaliphatic or aromatic,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

The invention also relates, according to another of its aspects, to the use of a composition in accordance with the invention for conferring, on said composition, a greater flow length in injection, in comparison with one and the same composition in which the polyamide of formula XY or A/XY, as defined according to the invention, is nonrecycled.

The invention also relates to the use of from 30% to 99.9% by weight of at least one recycled polyamide of formula XY or A/XY as defined according to the invention, in a composition as defined according to the invention, for conferring, on said composition, a greater flow length in injection, in comparison with one and the same composition in which the polyamide of formula XY or A/XY is nonrecycled.

The invention also relates, according to another of its aspects, to the use of a composition in accordance with the invention in the manufacture of objects, in particular single-material objects.

The invention also relates, according to another of its aspects, to an object, in particular a single-material object, consisting of at least 30% by weight, preferably of at least 50% by weight, of a composition in accordance with the invention.

### Recycled Polyamide of Formula XY or A/XY

The recycled polyamide according to the invention exhibits functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide.

Alternatively or additionally, the recycled polyamide of formula XY or A/XY according to the invention exhibits primary amine functions in a molar ratio, with respect to the secondary amide functions, which is lower than that of the same virgin polyamide.

According to one embodiment, a composition of the invention comprises from 30% to 99.9% by weight of at least one recycled polyamide of formula XY or A/XY as defined according to the invention exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide. According to this embodiment, said recycled polyamide of formula XY or A/XY, as defined according to the invention, may not exhibit primary amine functions in a molar ratio, with respect to the secondary amide functions, which is lower than that of the same virgin polyamide.

According to another embodiment, a composition of the invention comprises from 30% to 99.9% by weight of at least one recycled polyamide of formula XY or A/XY, as defined according to the invention, exhibiting primary amine functions in a molar ratio, with respect to the secondary amide functions, which is lower than that of the same virgin polyamide. According to this embodiment, said recycled polyamide of formula XY or A/XY, as defined according to the invention, may not exhibit functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide.

According to yet another embodiment, a composition of the invention comprises from 30% to 99.9% by weight of at least one recycled polyamide of formula XY or A/XY, as defined according to the invention, exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide and of at least one recycled polyamide of formula XY or A/XY, as defined according to the invention, exhibiting primary amine functions in a molar ratio, with respect to the secondary amide functions, which is lower than that of the same virgin polyamide.

According to this embodiment, a composition of the invention can comprise at least two different recycled polyamides, namely a first recycled polyamide of formula XY or A/XY, as defined according to the invention, exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide and a second recycled polyamide of formula XY or A/XY, as defined according to the invention, which is different from said first recycled polyamide of formula XY or A/XY, as defined according to the invention, exhibiting primary amine functions in a molar ratio, with respect to the secondary amide functions, which is lower than that of the same virgin polyamide.

Alternatively, and preferably, there may in particular be concerned one and the same polyamide exhibiting both (i) functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide and (ii) primary amine functions in a molar ratio, with respect to the secondary amide functions, which is lower than that of the same virgin polyamide.

According to one embodiment, the recycled polyamide of formula XY or A/XY of the invention more particularly comprises functions resulting from oxidation reactions chosen from benzamides, nitriles and primary amides in a molar ratio, with respect to the secondary amide functions, which is greater than that of the same virgin polyamide.

According to the invention, the molar ratio of at least one of the functions resulting from oxidation reactions as defined above, with respect to the secondary amide functions, can be greater for the recycled polyamide of formula XY or A/XY of the invention, in comparison with said molar ratio for one and the same virgin polyamide.

This means that if there is measured, on the one hand, the molar amount of one of the functions resulting from oxidation reactions as defined above and, on the other hand, the molar amount of the secondary amide functions in the recycled polyamide of formula XY or A/XY of the invention and if the ratio between these two molar amounts is determined (so as to obtain the molar ratio of said functions resulting from oxidation reactions, with respect to the secondary amide functions, for the recycled polyamide of formula XY or A/XY of the invention), said ratio will be greater than that calculated for one and the same virgin polyamide (that is to say, greater than the ratio between, on the one hand, the molar amount of one of the functions resulting from oxidation reactions as defined above and, on the other hand, the molar amount of the secondary amide functions in one and the same virgin polyamide).

In particular, according to the invention, the functions resulting from oxidation reactions can be present in the recycled polyamide of formula XY or A/XY of the invention in a molar ratio, with respect to the secondary amide functions, which is greater by at least 10%, for example greater by at least 100%, for example greater by at least 150%, for example greater by at least 300%, with respect to that of the same virgin polyamide.

The molar amounts of the functions resulting from oxidation reactions and the molar amounts of the secondary amide functions (and consequently the molar ratio between these two amounts) can be in particular measured by NMR, for example by proton NMR, in particular according to the conditions described below.

According to the invention, the molar ratio of the primary amine functions, with respect to the secondary amide functions, can be lower for the recycled polyamide of formula XY or A/XY of the invention, in comparison with said molar ratio for one and the same virgin polyamide.

Similarly to that which was set out above, this means that if there is measured, on the one hand, the molar amount of the primary amine functions and, on the other hand, the molar amount of the secondary amide functions in the recycled polyamide of formula XY or A/XY of the invention and if the ratio between these two molar amounts is determined (so as to obtain the molar ratio of the primary amine functions, with respect to the secondary amide functions, for the recycled polyamide of formula XY or A/XY of the invention), said ratio will be lower than that calculated for one and the same virgin polyamide (that is to say, lower than the ratio between, on the one hand, the molar amount of the primary amine functions and, on the other hand, the molar amount of the secondary amide functions in one and the same virgin polyamide).

In particular, according to the invention, the primary amine functions can be present in the recycled polyamide of formula XY or A/XY of the invention in a molar ratio, with respect to the secondary amide functions, which is lower by at least 10%, for example lower by at least 50%, for example lower by at least 100%, for example lower by at least 150%, with respect to that of the same virgin polyamide.

The molar amounts of the primary amine functions and the molar amounts of the secondary amide functions (and consequently the molar ratio between these two amounts) can be in particular measured by NMR, for example by proton NMR, in particular according to the conditions described below.

The compositions of the invention comprise from 30% to 99.9% by weight of at least one recycled polyamide of formula XY or A/XY, as defined according to the invention, with respect to the total weight of said composition.

According to one embodiment, the compositions of the invention can comprise from 50% to 99.5% by weight of said recycled polyamide of formula XY or A/XY, with respect to the total weight of the composition, for example from 70% to 99% by weight, for example from 80% to 98.5% by weight.

As indicated above, the polyamide of formula XY or A/XY used in the compositions according to the invention is recycled.

The term “recycled polyamide of formula XY or A/XY” is understood to denote, within the meaning of the invention, a polyamide of formula XY or A/XY as defined above resulting from post-industrial waste and/or from post-consumer waste, as are defined above.

More precisely, in the context of the present invention, the term “post-industrial waste” is understood to mean waste generated either by the manufacturing process which has resulted in the creation of the original source material or by the manufacturing process which has resulted, starting in particular from an original source material, in the creation of an object as are defined above, and which has been recycled at least once, preferably at least twice, in particular more than twice.

According to one embodiment, the recycled polyamide of formula XY or A/XY, as defined according to the invention, used in the compositions of the invention can in particular result from post-industrial waste as defined above, which can be collected, for example, after a manufacturing stage resulting in the creation of the original source material or after a manufacturing stage resulting, starting in particular from an original source material, in the creation of an object, such as a sports article, an article for a motor vehicle, such as, for example, an airplane, a drone, an aircraft, an electric bicycle, a moped, a motorcycle, a side car, a car, a van, a tractor, a truck, an urban bus, a long-distance bus, a snowmobile, a motor crawler, a bulldozer, a snow groomer and a tank, an electronic article for the general public, a medical article or an industrial article, and which has been recycled at least once, preferably at least twice, in particular more than twice. It can in particular concern scrap which has been processed in the molten state, that is to say at a temperature greater than its melting point (preferably at a temperature greater by at least 20° C., for example by at least 30° C., for example by at least 40° C., for example by at least 50° C., above its melting point).

Preferably, this scrap originates from extrusion or injection molding processes and has been recycled at least once, preferably at least twice, in particular more than twice. It can also concern articles of poor quality or incapable of performing their function, which are also regarded as waste, provided that it has been recycled at least once, preferably at least twice, in particular more than twice. This waste is subsequently generally ground in order to be used in a composition of the invention.

According to another embodiment, the recycled polyamide of formula XY or A/XY, as defined according to the invention, used in the compositions of the invention can in particular result from post-consumer waste. It can in particular concern sports articles, articles for a motor vehicle, such as, for example, an airplane, a drone, an aircraft, an electric bicycle, a moped, a motorcycle, a side car, a car, a van, a tractor, a truck, an urban bus, a long-distance bus, a snowmobile, a motor crawler, a bulldozer, a snow groomer and a tank, used electronic articles for the general public, used medical articles and/or used industrial articles which are collected after purchase and use, preferably repeated use, by the end consumer, or when they have reached the end of their life. The expression “used” denotes an article which is no longer new, has already been used or of which use has already been made. This expression does not cover under any circumstances post-consumer or post-industrial waste which would be recycled without having been used or of which use has not been made.

According to yet another embodiment, the recycled polyamide of formula XY or A/XY, as defined according to the invention, used in the compositions of the invention can result from a mixture of post-industrial waste and of post-consumer waste as are defined above. For example, post-industrial waste can be mixed with post-consumer waste, such as sports articles, articles for a motor vehicle, such as, for example, an airplane, a drone, an aircraft, an electric bicycle, a moped, a motorcycle, a side car, a car, a van, a tractor, a truck, an urban bus, a long-distance bus, a snowmobile, a motor crawler, a bulldozer, a snow groomer and a tank, used electronic articles for the general public, used medical articles and/or used industrial articles which are also ground subsequently.

In a particular embodiment of the invention, the expression “recycled polyamide of formula XY or A/XY” denotes only post-industrial waste as defined above. According to this embodiment, the composition of the invention is thus devoid of post-consumer waste as defined above.

In another particular embodiment of the invention, the expression “recycled polyamide of formula XY or A/XY” denotes only post-consumer waste as defined above. According to this embodiment, the composition of the invention is thus devoid of post-industrial waste as defined above.

According to one embodiment, the recycled polyamide of formula XY or A/XY used in the compositions of the invention does not result from a three-dimensional article manufactured from a composition in powder form, by layer-by-layer construction by sintering caused by electromagnetic radiation.

According to one embodiment, the composition of the invention is not intended to be used in the layer-by-layer construction of a three-dimensional article, by sintering of the composition caused by electromagnetic radiation.

As mentioned below, the recycled polyamide of formula XY or A/XY used according to the invention is modified with respect to one and the same virgin polyamide of formula XY or A/XY. In particular, oxidative stresses during the manufacture of the original source material, its subsequent use and/or its subsequent recycling, or also during the manufacture of an object as defined above, its subsequent use and/or its subsequent recycling, affect some of its bonds, such as, for example, its reactive functions and/or its hydrocarbon chain.

For example, in the case of post-consumer waste (such as, for example, spectacles, smart watches or motor vehicle interior parts), the objects have generally been exposed during their use, in all or in part, to conditions capable of affecting some of their bonds, such conditions including, for example, air, in particular oxygen, light, in particular UV rays, or also differences in temperatures, in particular high temperatures. In the case of sports or electronic articles, the objects could also have been exposed to the perspiration fluid of the persons who carried or wore them, to cosmetic products (such as, for example, suncream), to cleaning products (such as, for example, detergents of laundry type, in particular at temperatures of greater than 30° C.) and also to products of degradation by microorganisms.

The bonds of the polyamides of formula XY or A/XY can also be placed under oxidative stresses by multiple processing, granulation and compounding operations (for example, recycling of post-industrial scrap, granulation, compounding and processing after the first life or lives of the material).

The polyamides of formula XY or A/XY thus exhibit distinguishing features, and in particular new entities resulting from oxidation mechanisms, when they result from post-industrial waste and/or post-consumer waste as are defined above.

The expression “new entities resulting from oxidation mechanisms” is intended to denote, within the meaning of the invention, benzamide functions, nitriles, primary amides, chain-end methyl groups, alkenes, formamides, imides and carboxylic acids which can appear in the recycled polyamide of formula XY or A/XY of the invention.

The recycled polyamide of formula XY or A/XY of the invention exhibits functions resulting from oxidation reactions chosen from benzamide functions, nitriles, primary amides, chain-end methyl groups, alkenes, formamides, imides and carboxylic acids.

According to a preferred embodiment of the invention, the recycled polyamide of formula XY or A/XY of the invention exhibits functions resulting from oxidation reactions chosen from nitriles.

According to a preferred embodiment of the invention, the recycled polyamide of formula XY or A/XY of the invention exhibits functions resulting from oxidation reactions chosen from nitriles and benzamides in a molar ratio, with respect to the secondary amide functions, which is greater than that of the same virgin polyamide of formula XY or A/XY, and primary amine functions in a molar ratio, with respect to the secondary amide functions, which is lower than that of the same virgin polyamide of formula XY or A/XY.

These functions can be identified and quantified using infrared and/or proton or carbon NMR spectroscopy.

The NMR measurements can be carried out in the HFIP/CD₂Cl₂ mixture. For example, 20 mg of polymer can be dissolved in 0.7 ml of solvent with an HFIP/CD₂Cl₂ ratio of 1/3. The dichloromethane (CD₂Cl₂)/trifluoroacetic anhydride (TFAA) mixture can also be used.

This method is described in the doctoral thesis of E. Goncalves, in chapter II.2.3, published in 2011, incorporated by reference. Analyses in these two solvents make it possible to identify a majority of functions formed during the life of the polyamide of formula XY or A/XY of the invention.

Thus, by way of example, in infrared spectroscopy, the absorption band from 1700 to 1740 cm⁻¹ corresponds to an imide, that from 1680 to 1720 cm⁻¹ corresponds to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized, on the one hand, by a pair of absorption bands from 3100 to 3500 cm⁻¹ and from 15560 to 1640 cm⁻¹ which corresponds to the NH group of the amide and, on the other hand, by the absorption band from 1650 to 1700 cm⁻¹ which corresponds to the carbonyl group of the amide.

The absorption bands at 1180 and 1723 cm⁻¹ correspond to the formates. The bands at 900 and 1660 cm⁻¹ correspond to the alkenes.

For example, the degradation of the polyethers included in the polyamide elastomers, in particular PEBAs, can be quantified by infrared spectroscopy by comparing the ratio between the intensities of the bands at 1111 cm⁻¹ (vibration of the C—O bond of the ether group) or at 2791 cm⁻¹ (CH₂ in the α position with respect to the ether function) and the band at 1725 cm⁻¹ (carbonyl function).

Quantification by NMR is carried out, for example, by comparing the intensity of the lines of the functions not present in the virgin polymer with the lines corresponding to the CH₂ groups in the α position with respect to the amide or ether functions or to other CH₂ groups in the context of proton NMR. In carbon NMR, the intensity of the lines of the functions formed during the life of the polymer is compared with the intensity of the lines of the carbons of the amides or of the CH₂ groups.

Some of the abovementioned functions can, for example, be observed in 13C NMR in the HFIP/CD₂Cl₂ solvent. Thus, the line at 36 ppm corresponds to the CH₂ group in the α position with respect to the primary amide and that at 34 ppm corresponds to the CH₂ group in the α position with respect to the carboxylic acid. These entities can be quantified by integrating the area under the lines and comparing them with the area under the 37.1 ppm line corresponding to the secondary amide. Similarly, the lines corresponding to the carbonyl groups of the primary amide, carboxylic acid and secondary amide functions are observed at 181.2 ppm, 179.6 ppm and 177.4 ppm respectively. The line at 16.7 ppm corresponds to the CH₂ group in the α position with respect to the nitrile group. The formamide group gives chemical shifts at 163.0 ppm and 166.3 ppm.

Other functions mentioned above can be observed in proton NMR (1H NMR) in the HFIP/CD₂Cl₂ solvent as described above. The lines of the CHO groups of the formamides emerge at 7.92 and 8.01 ppm. The line corresponding to the CH₂ groups in the α position with respect to the primary amides can be observed at 2.30 ppm. The line at 0.9 ppm corresponds to the CH₃ group of CH₃—(CH₂) n type. The line at 2.40 ppm corresponds to the CH₂ group in the α position with respect to the nitrile function. The lines corresponding to the proton of the benzamide function are observed between 7.6 and 7.8 ppm. The line corresponding to the proton of the aldehyde function is observed at 9.7 ppm. Similarly to what is described for carbon NMR, the ratios of new functions, with respect to secondary amides, can be determined by integrating the area under the lines and by comparing them with the area under the line corresponding to the CH₂ group in the α position with respect to the secondary amide (2.20 ppm) or with the area under the line corresponding to the CONH proton of the secondary amide (6.0-6.1 ppm).

According to any one of the embodiments of the invention, in a recycled polyamide of formula XY or A/XY of the invention, the molar ratio of the functions resulting from oxidation reactions, with respect to the secondary amide functions, is of between 0.0005 and 0.3.

According to any one of the embodiments of the invention, in a recycled polyamide of formula XY or A/XY of the invention, the molar ratio of the imide functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the benzamide functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the alkene functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the primary amide functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the nitrile functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the formamide functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the carboxylic acid functions, with respect to the secondary amide functions, is of between 0.0005 and 0.1, in particular between 0.001 and 0.08, especially between 0.005 and 0.05.

According to any one of the embodiments of the invention, in a recycled polyamide of formula XY or A/XY of the invention, the molar ratio of the chain-end methyl functions, with respect to the secondary amide functions, is of between 0.0005 and 0.2, in particular between 0.001 and 0.08, especially between 0.005 and 0.05.

It is very obvious that, depending on the waste and on the exposure to which it will have been subjected, one or more functions resulting from oxidation reactions can be present.

The composition can also comprise residues of stabilizers chosen from phenols, quinones, stilbenequinones and phosphite.

The nomenclature used to define polyamides is described in the standard ISO 1874-1:2011, “Plastics-Polyamide (PA) moulding and extrusion materials-Part 1: Designation”, in particular on page 3 (Tables 1 and 2), and is well known to a person skilled in the art.

The term “polyamide” denotes both a homopolyamide and a copolyamide.

The polyamide can comprise aromatic or cycloaliphatic units or a mixture of the two.

Said polyamide advantageously exhibits a mean number of carbon atoms per nitrogen atom of greater than or equal to 6, preferably of greater than or equal to 8, especially of greater than or equal to 9, in particular of greater than or equal to 10.

The recycled polyamide used in the compositions of the invention is a polyamide of formula XY or A/XY in which:
A is an aliphatic repeat unit chosen from a unit obtained from the polycondensation of at least one amino acid, a unit obtained from the polycondensation of at least one lactam and a unit obtained from the polycondensation of at least one aliphatic diamine and of at least one aliphatic diacid,
X is at least one aliphatic or cycloaliphatic diamine, or one arylaliphatic or aromatic diamine, or a mixture of these, and
Y is at least one dicarboxylic acid, said diacid being chosen from a linear or branched aliphatic diacid, a cycloaliphatic diacid and an aromatic diacid, or a mixture of these,
   said diamine and said diacid comprising from 4 to 48 carbon atoms, advantageously from 6 to 18 carbon atoms,
   with at least one of X and/or Y being cycloaliphatic, arylaliphatic or aromatic.

According to one embodiment, when the polyamide of formula XY or A/XY of the invention comprises only one (or more) aliphatic diamine(s) X, it then comprises at least one cycloaliphatic or aromatic diacid Y.

According to another embodiment, when the polyamide of formula XY or A/XY of the invention comprises only one (or more) aliphatic diacid(s) Y, it then comprises at least one cycloaliphatic or aromatic diamine X.

According to another embodiment, when the polyamide of formula XY or A/XY of the invention comprises at least one cycloaliphatic or aromatic diacid Y, it then comprises at least one aliphatic or cycloaliphatic diamine X, or one arylaliphatic or aromatic diamine.

According to another embodiment, when the polyamide of formula XY or A/XY of the invention comprises at least one cycloaliphatic diamine X, or one arylaliphatic or aromatic diamine, it then comprises at least one aliphatic, cycloaliphatic or aromatic diacid Y.

### Regarding the Optional Repeat Unit A:

In a first alternative form of the invention, the repeat unit A is a unit obtained from the polycondensation of at least one C₄-C₃₆ amino acid (or aminocarboxylic acid).

Advantageously, said aminocarboxylic acid comprises from 9 to 12 carbon atoms. It can thus be chosen from 9-aminononanoic acid (denoted 9), 10-aminodecanoic acid (denoted 10), 11-aminoundecanoic acid (denoted 11) and 12-aminododecanoic acid (denoted 12); advantageously, the aminocarboxylic acid is 11-aminoundecanoic acid.

In a second alternative form of the invention, the repeat unit A is a unit obtained from the polycondensation of at least one C₄-C₃₆ lactam.

Advantageously, the lactam comprises from 9 to 12 carbon atoms. It can thus be chosen from decanolactam (denoted 10), undecanolactam (denoted 11) and laurolactam or lauryllactam (denoted 12); advantageously, the lactam is lauryllactam.

However, it is entirely possible to envisage employing a mixture of two or more aminocarboxylic acids, a mixture of two or more lactams, but also a mixture of one, two or more aminocarboxylic acids with one, two or more lactams.

More particularly preferably, the repeat unit A is obtained from a single aminocarboxylic acid or from a single lactam.

In a second alternative form of the invention, the repeat unit A is a unit obtained from the polycondensation of at least one aliphatic diamine and of at least one aliphatic diacid.

The at least one aliphatic diamine and the at least one aliphatic diacid are as defined below.

### Regarding the Repeat Unit XY:

The repeat unit XY is a unit obtained from the polycondensation of at least one diamine, said diamine being chosen from a linear or branched aliphatic diamine, a cycloaliphatic or aromatic diamine and a semi-arylaliphatic, or a mixture of these, and
of at least one dicarboxylic acid, said diacid being chosen from:
an aliphatic diacid, a cycloaliphatic diacid and an aromatic diacid or a mixture of these.

The molar proportions of diamine and of dicarboxylic acid are preferentially stoichiometric.

Said diamine comprises from 4 to 36 carbon atoms, advantageously from 6 to 18 carbon atoms.

According to one embodiment, said diamine comprises from 6 to 12 carbon atoms.

In the case where the diamine used to obtain this repeat unit XY is an aliphatic diamine which exhibits a linear main chain, this linear main chain can, if appropriate, comprise one or more methyl and/or ethyl substituent(s); in this latter configuration, the diamine is referred to as a “branched aliphatic diamine”. In the case where the main chain does not comprise any substituent, the aliphatic diamine is referred to as a “linear aliphatic diamine”.

Whether it does or does not comprise methyl and/or ethyl substituents on the main chain, the aliphatic diamine used to obtain this repeat unit XY comprises from 4 to 48 carbon atoms, advantageously from 6 to 18 carbon atoms, in particular from 9 to 18 carbon atoms.

When this diamine is a linear aliphatic diamine, it then corresponds to the formula H₂N—(CH₂)ₓ—NH₂ and can be chosen, for example, from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines which have just been mentioned can all be biobased within the meaning of the standard ASTM D6866.

When this diamine is a branched aliphatic diamine, it can in particular be 2-methylpentanediamine, 2-methyl-1,8-octanediamine or (2,2,4- or 2,4,4-)trimethylhexanediamine.

The cycloaliphatic diamine can be chosen, for example, from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane or 3,3′-dimethyl-4,4′-diaminodicyclohexylmethane, commonly referred to as “BMACM” or “MACM” (and denoted B hereinafter), bis(p-aminocyclohexyl)methane, commonly referred to as “PACM” (and denoted P hereinafter), isopropylidenedi(cyclohexylamine), commonly referred to as “PACP”, isophoronediamine (denoted IPD hereinafter), bis(4-amino-3-methylcyclohexyl)methane, commonly referred to as “TMDC”, and 2,6-bis(aminomethyl) norbornane, commonly referred to as “BAMN”, or bis(aminomethyl)cyclohexane, commonly referred to as “BAC”.

A nonexhaustive list of these cycloaliphatic diamines is given in the publication “Cycloaliphatic Amines” (Encyclopedia of Chemical Technology, Kirk-Othmer, 4th edition (1992), pp. 386-405).

When this diamine is an arylaliphatic diamine, it is, for example, chosen from 1,3-xylylenediamine and 1,4-xylylenediamine.

The dicarboxylic acid comprises from 4 to 48 carbon atoms, advantageously from 6 to 18 carbon atoms, in particular from 6 to 12 carbon atoms.

When the dicarboxylic acid is aliphatic, it can be chosen from linear or branched aliphatic dicarboxylic acids.

When the dicarboxylic acid is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and fatty acid dimers containing from 36 to 48 carbons.

The abovementioned fatty acid dimers are dimerized fatty acids obtained by oligomerization or polymerization of unsaturated monobasic fatty acids having a long hydrocarbon chain (such as linoleic acid and oleic acid), as described in particular in the document EP 0 471 566.

When the dicarboxylic acid Y is cycloaliphatic, it can comprise the following carbon backbones: norbornylmethane, cyclohexane, cyclohexylmethane, dicyclohexylmethane, dicyclohexylpropane, di(methylcyclohexyl) or di(methylcyclohexyl)propane.

When the dicarboxylic acid is aromatic, it can be chosen from terephthalic acid (denoted T), isophthalic acid (denoted I) and a naphthalenic acid (denoted N).

Advantageously, the dicarboxylic acid Y is aromatic and it can be chosen from terephthalic acid (denoted T) or isophthalic acid (denoted I).

In one embodiment, the semi-aromatic polyamide is a semicrystalline semi-aromatic polyamide, in particular a semi-aromatic polyamide of formula XT or A/XT in which A and X are as defined above and T is terephthalic acid.

The polyamide is in particular a polyamide of formula A/5T, A/6T, A/9T, A/10T or A/11T, A being as defined above, in particular a polyamide chosen from a PA 6T, a PA 9T, a PA 10T, a PA 12T, a PA 14T, a PA 16T, a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/6T, a PA 11/MPMDT/10T, a PA 11/BACT/10T, a PA 11/MXDT/10T or a PA 11/5T/10T.

In particular, the semicrystalline semi-aromatic polyamide is chosen from the polyamide 11/5T, 11/6T, 11/10T, MXDT/10T, MPMDT/10T or BACT/10T.

T corresponds to terephthalic acid, MXD corresponds to m-xylylenediamine, MPMD corresponds to methylpentamethylenediamine and BAC corresponds to bis(aminomethyl)cyclohexane.

In one embodiment, the Cb diacid of the unit A excludes itaconic acid.

In another embodiment, said at least one semi-aromatic polyamide is a polyamide of formula MXDY in which MXD corresponds to meta-xylylenediamine and Y is an aliphatic C₆ to C₁₈, in particular C₉ to C₁₈, especially C₉ to C₁₂, dicarboxylic acid.

Advantageously, said semi-aromatic polyamide of formula MXDY is chosen from MXD6, MXD10 and MXD12, in particular MXD10. In another embodiment, the polyamide is a polyamide of formula BY, PY, A/BY or A/PY in which A and Y are as defined above and B is 3,3′-dimethyl-4,4′-diaminodicyclohexylmethane, commonly referred to as “BMACM” or “MACM”, TMDC is bis(4-amino-3-methylcyclohexyl)methane and P is bis(p-aminocyclohexyl)methane, commonly referred to as “PACM”.

Advantageously, the polyamide is chosen from 11/B10, 12/B10, 11/P10, 12/P10, 11/BI/BT, 12/BI/BT, 11/PI/BT, 12/PI/BT, 11/PI/PT, 12/PI/PT, 11/BI, 12/BI, 11/PI, 12/PI, 1010/B10, B12, P12, P10, TMDC10, TMDC12, TMDC14, TMDC16 or TMDC18, in particular 11/B10.

According to one embodiment, the polyamide of formula XY or A/XY of the invention can be chosen from polyamides of formula XT, A/XT, PY, APY, BY or A/BY with B being BMACM or MACM, P being PACM and A, X and Y being as defined above.

According to one embodiment, the polyamide of formula XY or A/XY of the invention can be chosen in particular from PA 6T, PA 9T, PA 10T, PA 12T, PA 14T, PA 16T, PA MPMDT/6T, PA11/10T, PA 5T/10T, PA 11/BACT, PA 11/6T/10T, PA MXDT/10T, PA MPMDT/10T, PA BACT/10T, PA BACT/6T, PA BACT/10T/6T, PA 11/BACT/6T, PA 11/MPMDT/6T, PA 11/MPMDT/10T, PA 11/BACT/10T, PA 11/MXDT/10T, PA11/5T/10T, PA11/B10, PA12/B10, PA11/P10, PA12/P10, PA11/BI/BT, PA12/BI/BT, PA11/PI/BT, PA12/PI/BT, PA11/PI/PT, PA12/PI/PT, PA11/BI, PA12/BI, PA11/PI, PA12/PI, PA1010/B10, PAB12, PAP12, PAP10, PAMXD6, PAMXD10 and PAMXD12 and their mixtures.

In one embodiment, said semi-aromatic polyamide excludes 2-pyrrolidone units.

When the polyamide is a polyamide of formula A/XY, the A/XY molar ratio is advantageously of from 0.005/1 to 1/0.005, preferably from 0.01/1 to 1/0.5, in particular from 0.1/1 to 1/1, especially from 0.2/1 to 0.8/1.

Advantageously, the polyamide is partially or completely biobased.

In one embodiment, the polyamide is amorphous.

In one embodiment, the polyamide is semicrystalline.

In one embodiment, the polyamide has a C/N ratio of greater than 6.5, advantageously of greater than 7.5, preferably of greater than 8.5.

According to one embodiment of the invention, the virgin polyamide preferably has an inherent viscosity of greater than or equal to 0.9 dL/g, in particular of greater than or equal to 1.0 dL/g.

For example, the virgin polyamide can have an inherent viscosity of between 0.9 dL/g and 1.65 dL/g, for example between 1.0 dL/g and 1.4 dL/g.

The inherent viscosity is determined in m-cresol according to the standard ISO 307:2007 but while changing the solvent (use of m-cresol instead of sulfuric acid) and the temperature being 20° C.

According to one embodiment, the recycled polyamide of formula XY or A/XY of the invention is not provided in powder form.

In particular, according to one embodiment, the recycled polyamide of formula XY or A/XY of the invention is not provided in the form of particles having a size Dv10 of greater than or equal to 30 μm and/or in the form of particles having a size Dv90 of less than or equal to 250 μm and/or in the form of particles having a size Dv50 of 80 to 150 μm.

In the context of the present patent application:
the Dv10 corresponds to the threshold of the particle size for which 10% of the particles (by volume) have a size of less than the threshold and 90% of the particles (by volume) have a size of greater than the threshold;
the Dv50 corresponds to the threshold of the particle size for which 50% of the particles (by volume) have a size of less than the threshold and 50% of the particles (by volume) have a size of greater than the threshold;
the Dv90 corresponds to the threshold of the particle size for which 90% of the particles (by volume) have a size of less than the threshold, and 10% of the particles (by volume) have a size of greater than the threshold.

The Dv10, the Dv50 and the Dv90 are measured according to the standard ISO 9276-Parts 1 to 6: “Representation of results of particle size analysis”. It is possible to use, for example, a laser particle sizer (Sympatec Helos) and software (Fraunhofer) to obtain the volumetric distribution of a powder and to deduce the Dv10, the Dv50 and the Dv90 therefrom.

### Additives

Said recycled polyamide of formula XY or A/XY, whether it originates from post-industrial waste or post-consumer waste as defined above, results from polyamide grades of formula XY or A/XY which may possibly comprise additives.

As indicated above, the compositions according to the invention comprise at least 0.1% by weight of at least one additive, with respect to the total weight of said composition.

It is specified that the additive under consideration according to the invention is an additive which has been expressly added in a content of at least 0.1% by weight, with respect to the total weight of the composition, to the recycled polyamide of formula XY or A/XY in order to obtain a composition of the invention.

In other words, the additives which might already be present in the polyamide of formula XY or A/XY are not taken into consideration in the context of the present invention.

The used compositions exhibiting functions resulting from oxidation reactions as defined according to the invention are already partially degraded and cannot meet all the specifications if they are not reformulated.

It is in particular important to add at least one additive, preferably a stabilizer, especially a heat stabilizer, because all or part of the amount initially present of additive, in particular of stabilizer, was consumed during the first life and/or the multiple processing stages which have led to the formation of functions resulting from oxidation reactions as defined according to the invention.

In order to use these materials in high performance applications including criteria of durability over time, it is thus essential according to the invention to add such an additive, preferably stabilizers, in particular heat stabilizers.

The compositions of the invention can in particular comprise from 0.1% to 10% by weight of additives, with respect to the total weight of said composition, in particular from 0.3% to 6% by weight, for example from 0.5% to 2% by weight.

The additives present in the compositions of the invention are the conventional additives used which are well known to a person skilled in the art.

According to one embodiment, there may in particular be concerned at least one additive chosen from a catalyst, an antioxidant, a heat stabilizer, a UV absorber, a light stabilizer, a lubricant, a nucleating agent, a colorant, a wax and their mixtures.

The term “catalyst” denotes a polycondensation catalyst, such as an inorganic or organic acid.

Advantageously, the proportion by weight of catalyst is of from approximately 50 ppm to approximately 5000 ppm, in particular from approximately 100 to approximately 3000 ppm, with respect to the total weight of the composition.

Advantageously, a derivative of a metal chosen from the group formed by titanium, zirconium and hafnium or a strong acid, such as phosphoric acid, hypophosphorous acid or boric acid, is used as catalyst.

By way of example, the stabilizer can be a UV stabilizer, an organic stabilizer or more generally a combination of organic stabilizers, such as an antioxidant of phenol type (for example of the type of that of Irganox® 245 or 1098 or 1010 from Ciba-BASF), an antioxidant of phosphite type (for example Irgafos® 126 and Irgafos® 168 from Ciba-BASF) and indeed even optionally other stabilizers, such as a HALS, which means Hindered Amine Light Stabilizer (for example Tinuvin® 770 from Ciba-BASF), a UV stabilizer (for example Tinuvin® 312 from Ciba) or a phosphorus-based stabilizer. Use may also be made of antioxidants of amine type, such as Naugard® 445 from Crompton or also polyfunctional stabilizers, such as Nylostab® S-EED from Clariant.

This stabilizer can also be an inorganic stabilizer, such as a copper-based stabilizer. Mention may be made, as examples of such inorganic stabilizers, of copper halides and acetates. Incidentally, other metals, such as silver, may possibly be considered but these are known to be less effective. These copper-based compounds are typically combined with halides of alkali metals, in particular potassium.

According to one embodiment, the composition of the invention comprises less than 2% by weight, with respect to its total weight, of flow agent, preferably less than 1% by weight, preferably less than 0.5% by weight, preferably less than 0.1% by weight; preferably, it does not comprise a flow agent.

The term “flow agent” is understood to mean an agent which makes it possible to improve the flowability and also the leveling of a copolymer powder during a sintering process.

According to one embodiment, the composition of the invention comprises less than 2% by weight, with respect to its total weight, of flow agent in the form of particles having a mean size (Dv50) of less than or equal to 20 μm, preferably of less than or equal to 15 μm, preferably of less than or equal to 10 μm and more preferably of less than or equal to 1 μm.

Preferably, the composition of the invention comprises less than 1% by weight, preferably less than 0.5% by weight, preferably less than 0.1% by weight, of flow agent, and preferably it does not comprise a flow agent, in the form of particles having a mean size (Dv50) of less than or equal to 20 μm, preferably of less than or equal to 15 μm, preferably of less than or equal to 10 μm and more preferably of less than or equal to 1 μm. For example, the composition of the invention does not comprise a flow agent in the form of particles with a size Dv50 ranging from 10 nm to 100 nm, from 100 nm to 1 μm, from 1 μm to 20 μm.

According to one embodiment, the composition of the invention comprises less than 2% by weight, with respect to its total weight, of flow agent in the form of particles chosen from: silicas, precipitated silicas, hydrated silicas, vitreous silicas, fumed silicas, pyrogenic silicas, glassy phosphates, glassy borates, glassy oxides, amorphous alumina, titanium dioxide, talc, mica, kaolin, attapulgite, calcium silicates, alumina, magnesium silicates and their mixtures.

Preferably, the composition of the invention comprises less than 1% by weight, preferably less than 0.5% by weight, preferably less than 0.1% by weight, of flow agent, preferably it does not comprise a flow agent, in the form of particles chosen from: silicas, precipitated silicas, hydrated silicas, vitreous silicas, fumed silicas, pyrogenic silicas, glassy phosphates, glassy borates, glassy oxides, amorphous alumina, titanium dioxide, talc, mica, kaolin, attapulgite, calcium silicates, alumina, magnesium silicates and their mixtures.

### Virgin Polyamide

The compositions according to the invention can additionally comprise at least one virgin polyamide.

The term “virgin polyamide” is intended to denote, within the meaning of the invention, a polyamide which is not recycled, that is to say a polyamide which does not result from post-industrial waste and/or post-consumer waste, as are defined above.

In particular, the compositions of the invention can comprise from 0% to 70% by weight of at least one virgin polyamide, with respect to the total weight of said composition.

According to one embodiment, the compositions of the invention can comprise from 0.1% to 50% by weight of at least one virgin polyamide, with respect to the total weight of the composition, for example from 0.2% to 35% by weight, for example from 5% to 25% by weight.

According to any one of the embodiments of the invention, the virgin polyamide can be chosen from homopolyamides, copolyamides and copolymers comprising polyamide blocks and comprising flexible blocks or their mixtures.

According to one embodiment, the virgin polyamide can also be a blend of polyamide and at least one other polymer, the polyamide forming the matrix and the other polymer or polymers forming the dispersed phase.

Preferably, the virgin polyamide can be a condensation product:
of one or more amino acids;
of one or more lactams; or
of one or more salts or mixtures of diamines with diacids.

Mention may be made, as examples of amino acid, of α,ω-amino acids, such as aminocaproic, 7-aminoheptanoic, 11-aminoundecanoic, n-heptyl-11-aminoundecanoic and 12-aminododecanoic acids.

The lactam monomers comprise, preferably, between 3 and 12 carbon atoms on the main ring and can be substituted. Mention may be made, as examples of lactam, of β,β-dimethylpropiolactam, α,α-dimethylpropiolactam, amylolactam, caprolactam, capryllactam, enantholactam, 2-pyrrolidone and lauryllactam.

Preferably, the diamine participating in the composition of the virgin polyamide is an aliphatic diamine, an arylic diamine and/or a saturated cyclic diamine having from 6 to 12 carbon atoms. Mention may be made, as examples of diamine, of hexamethylenediamine, decanediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPDM), bis(aminocyclohexyl)methane (BACM), bis(3-methyl-4-aminocyclohexyl)methane (BMACM), meta-xylylenediamine, bis(p-aminocyclohexyl)methane and trimethylhexamethylenediamine.

Preferably, the dicarboxylic acid participating in the composition of the virgin polyamide has between 4 and 18 carbon atoms. Mention may be made, as examples of dicarboxylic acid, of adipic acid, sebacic acid, azelaic acid, suberic acid, isophthalic acid, butanedioic acid, 1,4-cyclohexanedicarboxylic acid, terephthalic acid, the sodium or lithium salt of sulfoisophthalic acid, dimerized fatty acids (these dimerized fatty acids have a dimer content of at least 98% and are preferably hydrogenated) and dodecanedioic acid HOOC—(CH₂)₁₀—COOH).

Preferably, the virgin copolyamide results from the condensation of at least two different monomers, for example of at least two different α,ω-aminocarboxylic acids or of two different lactams or of a lactam and of an α,ω-aminocarboxylic acid with different carbon numbers. Mention may also be made of copolyamides resulting from the condensation of at least one α,ω-aminocarboxylic acid (or one lactam), at least one diamine and at least one dicarboxylic acid. Mention may also be made of copolyamides resulting from the condensation of an aliphatic diamine with an aliphatic dicarboxylic acid and at least one other monomer chosen from aliphatic diamines other than the preceding one and aliphatic diacids other than the preceding one.

Preferably, the virgin polyamide can comprise at least one polyamide or copolyamide comprising at least one monomer selected from the group consisting of 46, 4T, 54, 59, 510, 512, 513, 514, 516, 518, 536, 6, 64, 66, 69, 610, 612, 613, 614, 616, 618, 636, 6T, 9, 913, 104, 109, 1010, 1011, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14 and their mixtures.

Preferably, the virgin polyamide is selected from the group consisting of PA 6, PA 66, PA 1010, PA 11, PA 12, PA 1011, PA 610, PA 612, PA 613 and their mixtures.

Mention may be made, as examples of copolyamides, of copolymers of caprolactam and of lauryllactam (PA 6/12), copolymers of caprolactam, of adipic acid and of hexamethylenediamine (PA 6/66), copolymers of caprolactam, of lauryllactam, of adipic acid and of hexamethylenediamine (PA Jun. 12, 1966), copolymers of caprolactam, of lauryllactam, of 11-aminoundecanoic acid, of azelaic acid and of hexamethylenediamine (PA 6/69/11/12), copolymers of caprolactam, of lauryllactam, of 11-aminoundecanoic acid, of adipic acid and of hexamethylenediamine (PA 6/66/11/12), copolymers of lauryllactam, of azelaic acid and of hexamethylenediamine (PA 69/12), copolymers of 11-aminoundecanoic acid, of terephthalic acid and of decamethylenediamine (PA 11/10T).

Preferably, the average number of carbon atoms (C) with respect to the nitrogen atom (N) (that is to say, the C/N ratio) of the virgin polyamide is greater than 6.5, advantageously greater than 7.5, preferably greater than 8.5, in particular greater than or equal to 10, preferably greater than or equal to 11. Particularly preferably, the mean number of carbon atoms (C) with respect to the nitrogen atom (N) of the virgin polyamide is 11 or 12.

Preferably, the virgin polyamide is chosen from PA 11, PA 1010, PA 1012, PA 12, PA 1212, PA 1014 or PA 1214 and their mixtures, preferably PA11 or PA12 or a mixture of these.

There may also be concerned a copolymer comprising polyamide blocks and comprising flexible blocks as defined, for example, in the application WO 2019/097184 on behalf of Arkema France, and in particular a copolymer comprising polyamide blocks and comprising polyether blocks (PEBA).

Preferably, the polyamide of the rigid block of said PEBA can have a C/N ratio of greater than 6.5, advantageously of greater than 7.5, preferably of greater than 8.5.

The nomenclature used to define polyamides is described in the standard ISO 1874-1:2011, “Plastics—Polyamide (PA) moulding and extrusion materials—Part 1: Designation”, in particular on page 3 (Tables 1 and 2), and is well known to a person skilled in the art.

According to a preferred embodiment of the invention, the polyamide of formula XY or A/XY of the invention and the virgin polyamide (or the polyamide block of the virgin PEBA) have the same C/N ratio. For example, the polyamide of formula XY or A/XY of the invention can be PAMXD10 and the virgin polyamide (or the polyamide block of the virgin PEBA) can be PA10T.

According to another preferred embodiment of the invention, the polyamide of formula XY or A/XY of the invention and the virgin polyamide (or the polyamide block of the virgin PEBA) are identical in nature. For example, the polyamide of formula XY or A/XY of the invention can be 11/BI/BT and the virgin polyamide (or the polyamide block of the virgin PEBA) can be 11/BI/BT. According to another example, the polyamide of formula XY or A/XY of the invention can be PA11 and the virgin polyamide (or the polyamide block of the virgin PEBA) can be PA11.

According to yet another embodiment of the invention, the difference between, on the one hand, the C/N ratio of the polyamide of formula XY or A/XY of the invention and, on the other hand, the C/N ratio of the virgin polyamide (or of the polyamide block of the virgin PEBA) can be less than or equal to 3, in particular less than or equal to 2, in particular less than or equal to 1. For example, the polyamide of formula XY or A/XY of the invention can be PA11/10T and the virgin polyamide (or the polyamide block of the virgin PEBA) can be PA11. According to another example, the polyamide of formula XY or A/XY of the invention can be PAB12 and the virgin polyamide (or the polyamide block of the virgin PEBA) can be PA12.

According to one embodiment of the invention, the virgin polyamide preferably has an inherent viscosity of greater than or equal to 0.9 dL/g, in particular of greater than or equal to 1.0 dL/g.

For example, the virgin polyamide can have an inherent viscosity of between 0.9 dL/g and 1.65 dL/g, for example between 1.0 dL/g and 1.4 dL/g.

The inherent viscosity is determined in m-cresol according to the standard ISO 307:2007 but while changing the solvent (use of m-cresol instead of sulfuric acid) and the temperature being 20° C.

### Impact Modifier

The compositions according to the invention can additionally comprise at least one impact modifier.

In particular, the compositions of the invention can comprise from 0% to 30% by weight of at least one impact modifier, with respect to the total weight of said composition.

According to one embodiment, the compositions of the invention can comprise from 1% to 25% by weight of at least one impact modifier, with respect to the total weight of the composition, for example from 3% to 20% by weight, for example from 6% to 15% by weight.

The impact modifier advantageously consists of a polymer exhibiting a flexural modulus of less than 100 MPa, measured according to the standard ISO 178:2010, determined at 23° C. with a relative humidity: RH of 50%, and with a Tg of less than 0° C. (measured according to the standard 11357-2:2013 at the inflection point of the DSC thermogram, at a heating rate of 20 K/min), in particular a polyolefin.

The polyolefin of the impact modifier may or may not be functionalized or be a mixture of at least one which is functionalized and/or of at least one which is nonfunctionalized. For simplicity, the polyolefin has been denoted by (B) and functionalized polyolefins (B1) and nonfunctionalized polyolefins (B2) have been described below.

A nonfunctionalized polyolefin (B2) is conventionally a homopolymer or copolymer of α-olefins or of diolefins, such as, for example, ethylene, propylene, 1-butene, 1-octene or butadiene. Mention may be made, by way of examples, of:
polyethylene homopolymers and copolymers, in particular LDPE, HDPE, LLDPE (linear low density polyethylene), VLDPE (very low density polyethylene) and metallocene polyethylene,
propylene homopolymers or copolymers,
ethylene/α-olefin, such as ethylene/propylene, copolymers, EPRs (abbreviation for ethylene propylene rubber) and ethylene/propylene/diene (EPDM) copolymers,
styrene/ethylene-butene/styrene (SEBS), styrene/butadiene/styrene (SBS), styrene/isoprene/styrene (SIS) and styrene/ethylene-propylene/styrene (SEPS) block copolymers,
copolymers of ethylene with at least one product chosen from salts or esters of unsaturated carboxylic acids, such as alkyl (meth)acrylate (for example methyl acrylate), or vinyl esters of saturated carboxylic acids, such as vinyl acetate (EVA), it being possible for the proportion of comonomer to reach 40% by weight.

The functionalized polyolefin (B1) can be a polymer of α-olefins having reactive units (the functionalities); such reactive units are acid, anhydride or epoxy functions. Mention may be made, by way of example, of the preceding polyolefins (B2) grafted or co- or terpolymerized with unsaturated epoxides, such as glycidyl (meth)acrylate, or with carboxylic acids or the corresponding salts or esters, such as (meth)acrylic acid (it being possible for the latter to be completely or partially neutralized by metals, such as Zn, and the like), or also with carboxylic acid anhydrides, such as maleic anhydride. A functionalized polyolefin is, for example, a PE/EPR blend, the ratio by weight of which can vary within broad limits, for example between 40/60 and 90/10, said blend being cografted with an anhydride, in particular maleic anhydride, according to a degree of grafting, for example, of from 0.01% to 5% by weight.

The functionalized polyolefin (B1) can be chosen from the following (co) polymers, which are grafted with maleic anhydride or glycidyl methacrylate, in which the degree of grafting is, for example, of from 0.01% to 5% by weight:
PE, PP, copolymers of ethylene with propylene, butene, hexene or octene containing, for example, from 35% to 80% by weight of ethylene;
ethylene/α-olefin, such as ethylene/propylene, copolymers, EPRs (abbreviation for ethylene propylene rubber) and ethylene/propylene/diene (EPDM) copolymers,
   styrene/ethylene-butene/styrene (SEBS), styrene/butadiene/styrene (SBS), styrene/isoprene/styrene (SIS) and styrene/ethylene-propylene/styrene (SEPS) block copolymers,
copolymers of ethylene and vinyl acetate (EVA), containing up to 40% by weight of vinyl acetate;
copolymers of ethylene and alkyl (meth)acrylate, containing up to 40% by weight of alkyl (meth)acrylate;
copolymers of ethylene and vinyl acetate (EVA) and alkyl (meth)acrylate, containing up to 40% by weight of comonomers.

The functionalized polyolefin (B1) can also be chosen from ethylene/propylene copolymers, predominant in propylene, grafted with maleic anhydride and then condensed with monoaminated polyamide (or a monoaminated polyamide oligomer) (products described in EP-A-0 342 066).

The functionalized polyolefin (B1) can also be a co- or terpolymer of at least the following units: (1) ethylene, (2)alkyl (meth)acrylate or saturated carboxylic acid vinyl ester and (3) anhydride, such as maleic anhydride, or (meth)acrylic acid or epoxy, such as glycidyl (meth)acrylate.

Mention may be made, by way of examples of functionalized polyolefins of the latter type, of the following copolymers, where ethylene preferably represents at least 60% by weight and where the termonomer (the function) represents, for example, from 0.1% to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the copolymers which precede, the (meth)acrylic acid can be salified with Zn or Li.

The term “alkyl (meth)acrylate” in (B1) or (B2) denotes C₁-C₈ alkyl methacrylates and acrylates and can be chosen from methyl acrylate, ethyl acrylate, n-butyl acrylate, isobutyl acrylate, 2-ethylhexyl acrylate, cyclohexyl acrylate, methyl methacrylate and ethyl methacrylate.

Moreover, the abovementioned polyolefins (B1) can also be crosslinked by any appropriate process or agent (diepoxy, diacid, peroxide, and the like); the term “functionalized polyolefin” also comprises the mixtures of the abovementioned polyolefins with a difunctional reactant, such as diacid, dianhydride, diepoxy, and the like, which is capable of reacting with these abovementioned polyolefins or the blends of at least two functionalized polyolefins which can react together.

The abovementioned copolymers, (B1) and (B2), can be copolymerized in random or block fashion and can exhibit a linear or branched structure.

The molecular weight, the MFI index and the density of these polyolefins can also vary within a broad range, which will be perceived by a person skilled in the art. MFI is the abbreviation for Melt Flow Index. It is measured according to the standard ASTM 1238.

Advantageously, the nonfunctionalized polyolefins (B2) are chosen from polypropylene homopolymers or copolymers and any ethylene homopolymer or copolymer of ethylene and of a comonomer of higher α-olefin type, such as butene, hexene, octene or 4-methyl-1-pentene. Mention may be made, for example, of PPs, high density PEs, medium density PEs, linear low density PEs, low density PEs or very low density PEs. These polyethylenes are known by a person skilled in the art as being produced according to a “radical” process, according to a catalysis of “Ziegler” type or, more recently, according to a “metallocene” catalysis.

Advantageously, the functionalized polyolefins (B1) are chosen from any polymer comprising α-olefin units and units carrying polar reactive functions, such as epoxy, carboxylic acid or carboxylic acid anhydride functions. Mention may be made, by way of examples of such polymers, of terpolymers of ethylene, of alkyl acrylate and of maleic anhydride or of glycidyl methacrylate, such as the Lotader® products from SK Functional Polymer, or polyolefins grafted with maleic anhydride, such as the Orevac® products from SK Functional Polymer, and also terpolymers of ethylene, of alkyl acrylate and of (meth)acrylic acid. Mention may also be made of polypropylene homopolymers or copolymers grafted with a carboxylic acid anhydride and then condensed with monoaminated polyamides or monoaminated polyamide oligomers.

### Filler

The compositions according to the invention can additionally comprise at least one filler.

In particular, the compositions of the invention can comprise from 0% to 65% by weight of at least one filler, with respect to the total weight of said composition.

According to one embodiment, the compositions of the invention can comprise from 2% to 30% by weight of at least one filler, with respect to the total weight of the composition, for example from 5% to 25% by weight, for example from 6% to 20% by weight.

The fillers can be chosen from:
reinforcing fibers can be chosen from glass fibers, carbon fibers, natural fibers (wood, flax, cellulose, hemp, and the like),
current-conducting fillers, such as carbon black and carbon nanotubes,
flame retardants (HFFRs),
fillers making it possible to reduce the density of the composition, such as glass beads, which are in particular hollow,
heat-conducting fillers chosen from metal oxides (Al₂O₃, Al₂SiO₅, and the like) or ceramics (BN, AlN, and the like).

According to one embodiment, a composition of the invention can in particular comprise reinforcing fibers, which are in particular fibers of inorganic, organic or plant origin. Said reinforcing fiber may or may not be sized.

Said reinforcing fiber can thus comprise up to 0.1% by weight of a material of organic nature (thermosetting or thermoplastic resin type) known as size.

Mention may be made, among the fibers of inorganic origin, of carbon fibers, glass fibers, basalt fibers or basalt-based fibers, silica fibers or silicon carbide fibers, for example.

Mention may be made, among the fibers of organic origin, of fibers based on a thermoplastic or thermosetting polymer, such as fibers of semiaromatic polyamides, aramid fibers, or fibers made of polyolefins, for example. Mention may be made, among the fibers of plant origin, of natural fibers based on flax, on hemp, on lignin, on bamboo, on silk, in particular spider silk, on sisal, and on other cellulose fibers, in particular viscose fibers. These fibers of plant origin can be used pure, treated or else coated with a coating layer, for the purpose of facilitating the adhesion and the impregnation of the thermoplastic polymer matrix.

Preferably, said reinforcing fiber is chosen from glass fibers, carbon fibers, basalt fibers and basalt-based fibers.

More advantageously, said reinforcing fiber is chosen from carbon fibers and glass fibers.

In one embodiment, the reinforcing fibers present in a) are glass fibers.

The glass fibers can be of circular or noncircular cross section. Advantageously, the glass fibers are circular. The glass fibers are in particular of E, R, S2 or T type. Advantageously, the glass fibers are of E type.

In one embodiment, the fillers are recycled. For the fillers comprising glass, they can in particular be manufactured from industrial production waste or post-consumer glass waste. The carbon fibers can, for example, originate from the cutting of reels of expired long fibers, in particular carbon fibers for the aeronautical industry.

### Plasticizers

The compositions according to the invention can additionally comprise at least one plasticizer.

In particular, the compositions of the invention can comprise from 0% to 15% by weight of at least one plasticizer, with respect to the total weight of said composition.

According to one embodiment, the compositions of the invention can comprise from 4% to 13% by weight of at least one plasticizer, with respect to the total weight of the composition, for example from 6% to 12% by weight.

By way of example, the plasticizers are chosen from benzenesulfonamide derivatives, such as n-butylbenzenesulfonamide (BBSA); ethyltoluenesulfonamide or N-cyclohexyltoluenesulfonamide; esters of hydroxybenzoic acids, such as 2-ethylhexyl para-hydroxybenzoate and 2-hexyldecyl para-hydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

It would not constitute a departure from the scope of the invention to use a mixture of plasticizers.

### Composition, Use and Process

As indicated above, the compositions of the invention comprise at least:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

According to one embodiment, the compositions of the invention comprise:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler, and
(e) from 0% to 15% by weight of at least one plasticizer,
the sum of the constituents (a)-(e) being equal to 100%.

In particular, according to this embodiment, the compositions of the invention consist of:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler, and
(e) from 0% to 15% by weight of at least one plasticizer,
the sum of the constituents (a)-(e) being equal to 100%.

According to another embodiment, the compositions of the invention comprise:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler, and
(e) from 0% to 30% by weight of at least one impact modifier,
the sum of the constituents (a)-(e) being equal to 100%.

In particular, according to this embodiment, the compositions of the invention consist of:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler, and
(e) from 0% to 30% by weight of at least one impact modifier,
the sum of the constituents (a)-(e) being equal to 100%.

According to one embodiment, the compositions of the invention comprise:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 15% by weight of at least one plasticizer, and
(e) from 0% to 30% by weight of at least one impact modifier,
the sum of the constituents (a)-(e) being equal to 100%.

In particular, according to this embodiment, the compositions of the invention consist of:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 15% by weight of at least one plasticizer, and
(e) from 0% to 30% by weight of at least one impact modifier, the sum of the constituents (a)-(e) being equal to 100%.

According to another embodiment, the compositions of the invention comprise:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier,
the sum of the constituents (a)-(f) being equal to 100%.

In particular, according to this embodiment, the compositions of the invention consist of:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier,
the sum of the constituents (a)-(f) being equal to 100%.

According to one embodiment, the recycled polyamide of formula XY or A/XY of the invention does not originate from a used single-layer and/or multilayer tube and/or tank which has initially transported or contained fluids for motor vehicles, in particular for automobiles.

According to one embodiment, the composition of the invention is not intended for the manufacture of tubes for the transportation of fluids for motor vehicles, in particular for automobiles. According to one embodiment, the recycled polyamide of formula XY or A/XY of the invention does not originated from a tube.

According to one embodiment, the composition of the invention comprises less than 5% by weight of plasticizer, for example less than 3% by weight of plasticizer, for example less than 1% by weight of plasticizer, for example less than 0.5% by weight of plasticizer, with respect to the total weight of the composition. In particular, the composition of the invention can be devoid of plasticizer, that is to say contain 0% by weight of plasticizer, with respect to the total weight of the composition.

According to one embodiment, the composition of the invention comprises less than 5% by weight of impact modifier, for example less than 3% by weight of impact modifier, for example less than 1% by weight of impact modifier, for example less than 0.5% by weight of impact modifier, with respect to the total weight of the composition. In particular, the composition of the invention can be devoid of impact modifier, that is to say contain 0% by weight of impact modifier, with respect to the total weight of the composition.

According to one embodiment, the composition of the invention comprises less than 5% by weight of plasticizer and of impact modifier, for example less than 3% by weight of plasticizer and of impact modifier, for example less than 1% by weight of plasticizer and of impact modifier, for example less than 0.5% by weight of plasticizer and of impact modifier, with respect to the total weight of the composition. In particular, the composition of the invention can be devoid of plasticizer and of impact modifier, that is to say contain 0% by weight of plasticizer and of impact modifier, with respect to the total weight of the composition.

According to one embodiment, the composition of the invention comprises only one or more recycled polyamides of the same nature.

According to one embodiment, the composition of the invention comprises MXD6 in a content of greater than 25% by weight, in particular of greater than 50% by weight, with respect to the total weight of said composition. According to one embodiment, the composition of the invention comprises 9T in a content of greater than 25% by weight, in particular of greater than 50% by weight, with respect to the total weight of said composition.

According to one embodiment, the composition of the invention does not comprise MXD6.

According to one embodiment, the composition of the invention does not comprise 9T.

According to any one of the embodiments of the invention, the composition of the invention can be provided present in the form of solid particles with a median diameter D50 of less than 20 mm, preferably of between 0.1 and 10 mm.

The inventors have discovered, surprisingly, that the compositions of the invention exhibit a better processability, compared in particular with compositions devoid of recycled polyamide of formula XY or A/XY of the invention. In particular, the compositions of the invention advantageously exhibit a greater flow length in injection, in comparison with one and the same composition in which the polyamide of formula XY or A/XY is nonrecycled.

The invention thus relates, according to another of its aspects, to the use of a composition as defined above for conferring, on said composition, a greater flow length in injection, in comparison with one and the same composition in which the polyamide of formula XY or A/XY is nonrecycled.

As indicated above, the compositions of the invention advantageously exhibit properties sufficient to make possible their use in high performance applications and not only in lower performance applications, such as in street furniture or roads.

In particular, it has been demonstrated that the compositions of the invention make it possible to manufacture objects, in particular single-material objects, exhibiting good mechanical properties.

Advantageously, the composition of the invention can make it possible to retain good mechanical properties (for example in terms of impact strength, of low density, of modulus, of stress and of elongation at yield, in particular at high temperature, of stress and of elongation at break, in particular at high temperature) and an ability to adhere to different substrates similar to that of virgin polyamides.

Advantageously, the compositions of the invention can additionally make it possible to maintain a chemical resistance similar to that of virgin polymers.

This is why, according to another of its aspects, the present invention relates to the use of a composition as defined above in the manufacture of objects, in particular single-material objects.

According to another of its aspects, the present invention also relates to an object, in particular a single-material object, consisting of at least 30% by weight, preferably of at least 50% by weight, of a composition according to the invention.

There may in particular be concerned a single-material object comprising at least two elements:
at least one first element consisting of a first composition comprising, by weight, at least 30% of at least one recycled polyamide of formula XY or A/XY as defined above,
at least one second element consisting of a second composition comprising, by weight, at least 30% of at least one recycled polyamide of formula XY or A/XY as defined above, it being possible for said first and second elements to adhere, at least partially, to each other,

The term “single-material object” should be understood as meaning an object predominantly consisting of the same

material, to be specific a recycled polyamide of formula XY or A/XY as defined above in the two compositions.

In a first alternative form, the single-material objects can be, without being limited to these:
an electronic article, in particular a watch, a telephone case, headphones, earphones, a loudspeaker, a keyboard, a mouse, a telephone charger,
an article of clothing, in particular a jacket, trousers, a T-shirt or socks,
an optical article, in particular prescription glasses, sunglasses, children's glasses, sports glasses and a ski mask, augmented reality/virtual reality goggles,
a household electrical article, in particular a small household electrical appliance, a household electrical article accessory (bowl, mixing paddle, food container), a flask, a food container,
a cosmetic article, in particular cosmetic packaging, such as a bottle, a fragrance, makeup packaging, skincare packaging, a display article, a hairbrush,
a sports article, in particular a surfboard (and its accessories, such as a leash or daggerboards), a bicycle, a bicycle article, such as a saddle or pedal, a helmet, a ski boot, skis, ski poles, a ski binding and a snowboard (excluding metal), a golf club, any type of racket, in particular a tennis racket, protective equipment, such as a shin guard, elbow pad, and the like, a hockey (on grass and ice) stick, a roller skate, diving flippers,
an article of luggage, in particular a suitcase, a rucksack and a handbag,
a stationery article, in particular pens,
a toy,
furniture, and
parts for a motor vehicle, such as, for example, an airplane, a drone, an aircraft, an electric bicycle, a moped, a motorcycle, a side car, a car, a van, a tractor, a truck, an urban bus, a long-distance bus, a snowmobile, a motor crawler, a bulldozer, a snow groomer and a tank.

In one embodiment, at least 50% by weight of recycled polyamide of formula XY or A/XY is present in each of the two elements, with respect to the total weight of the composition of each element.

In other words, the sum by weight of recycled polyamide of formula XY or A/XY in the first element and of recycled polyamide of formula XY or A/XY in the second element is at least 50%, with respect to the total weight of the two compositions of each element.

In another embodiment, the matrix of each of the two elements (fillers and additives excluded) consists of 60% by weight, advantageously 80% by weight, preferably 100% by weight, of recycled polyamide of formula XY or A/XY as defined above.

The term “element” denotes each of the things, the combination, the meeting, of which forms another thing, a whole, namely, in the present invention, a single-material object.

In particular, an element denotes a component, a constituent, a fragment, a piece, a part or unit which constitutes the single-material object.

The expression “it being possible for said first and second elements to adhere, at least partially, to each other” means that said first and second elements may or may not adhere to each other.

In one embodiment, said first and second elements are devoid of adhesion to each other.

In another embodiment, said first and second elements adhere to each other, this being at least partially, in particular completely.

The term “adheres” means that said first and second elements are placed side by side one against the other or applied one against the other, at least partially and in particular by adhesive bonding, clip-fastening, overmolding, thermoforming, screwing, sewing, welding or riveting.

It is very obvious that said first and second compositions which comprise a recycled polyamide of formula XY or A/XY as defined above can also comprise additives and, optionally, impact modifiers and/or plasticizers and/or fillers as defined above.

According to one embodiment, the invention also relates to a process for the manufacture of an object employing solid particles as defined above, by remelting said particles and then shaping an object by extrusion, molding or blowing of the melted particles.

The invention is also targeted at protecting an object, in particular a single-material object, capable of being obtained by such a process. There may in particular be concerned a single-material object as defined above.

According to yet another of its aspects, the invention is targeted at protecting an extruded, molded or blown part, for example an injection molded part, a composite comprising continuous fibers, a film, a fiber, a yarn or a filament.

According to one embodiment, the invention relates to a process for the manufacture of a composition as defined above, comprising at least the following stages:
a) having available post-industrial waste and/or post-consumer waste, in particular as are defined above,
b) grinding said post-industrial waste and/or said post-consumer waste,
c) optionally, carrying out a granulation of the ground material obtained on conclusion of stage b),
d) preparing said composition, for example by means of an extruder.

The process for the manufacture of a composition of the invention comprising at least one stage consisting in adding at least one additive as defined above to the recycled polyamide of formula XY or A/XY as defined above.

According to one embodiment, stage d) of the manufacturing process described above comprises at least the addition of from 0.1% to 10% by weight of additives, with respect to the total weight of said composition, in particular from 0.3% to 6% by weight, for example from 0.5% to 2% by weight.

According to one embodiment, step d) of the manufacturing process described above comprises at least the mixing of from 30% to 99.9% by weight of at least one recycled polyamide of formula XY or A/XY exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide, and of from 0.1% to 10% by weight of at least one additive, the contents being expressed by weight with respect to the total weight of the composition.

This stage can also comprise the additional mixing of from 0% to 70% by weight of at least one virgin polyamide, from 0% to 65% by weight of at least one filler, from 0% to 15% by weight of at least one plasticizer and/or from 0% to 30% by weight of at least one impact modifier.

According to one embodiment, stage d) consists in preparing said composition using an extruder, preferably a twin-screw extruder, or a co-kneader, in order to form granules, an extrudate or a powder.

Alternatively, it is possible to proceed to the manufacture of a composition of the invention by carrying out a stage of premixing (rough homogenization) of the solid particles as defined above before the transformation stage. This premixing stage is generally carried out at a temperature lower than the melting point of said solid particles.

The invention will be explained in greater detail in the examples which follow.

Unless otherwise mentioned, in that which follows, the percentages are expressed by weight, with respect to the total weight of the composition.

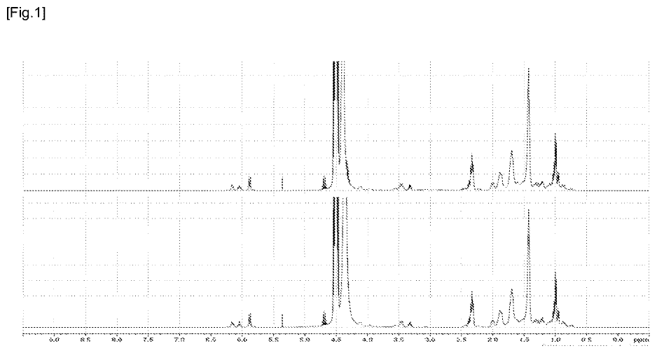

FIG. 1 represents the complete 1H NMR spectrum in a mixture of solvents HFIP/CD₂Cl₂ (in an HFIP/CD₂Cl₂ ratio of 1/3) of the PA of the examples (bottom spectrum: virgin PA and top spectrum: recycled PA).

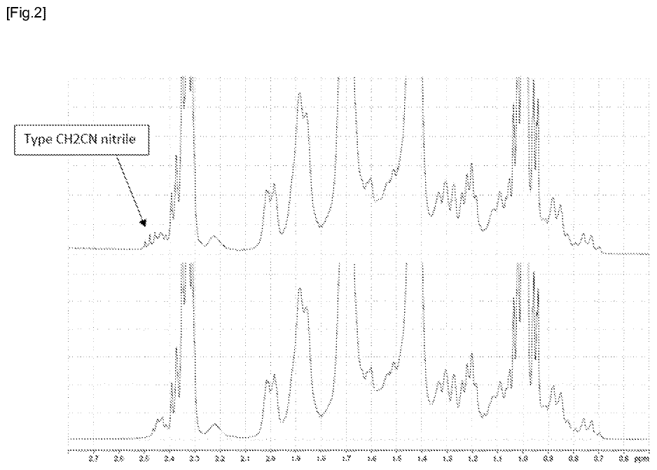

FIG. 2 represents an enlargement of the NMR spectrum of FIG. 1 in the 2.8 ppm-0.5 ppm region (bottom spectrum: virgin PA and top spectrum: recycled PA).

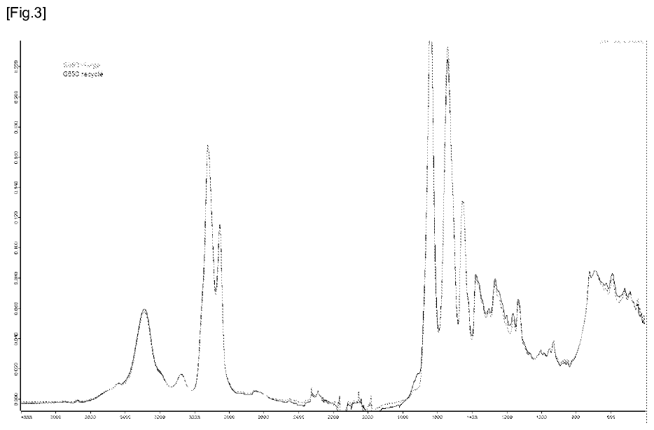

FIG. 3 represents an overlay of the FTIR infrared spectra in ATR mode of the PA of the examples (in gray: virgin PA/in black: recycled PA).

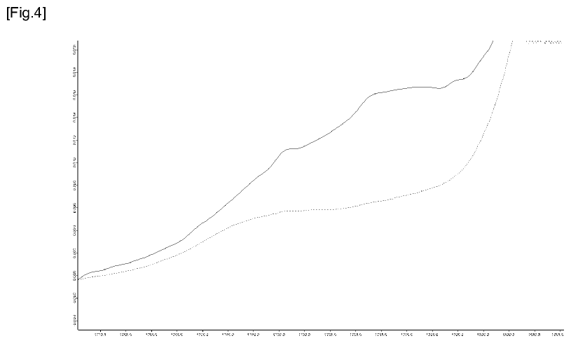

FIG. 4 represents an enlargement of the ATR-FTIR spectra of FIG. 3 in the 1770-1680 cm⁻¹ region.

### EXAMPLES

The examples of tables 1 and 2 below are obtained from compositions comprising the following polyamide:
PA 1: copolyamide 11/B10 (molar ratio 0.13/1)
PA 2: copolyamide 12/BI/BT (molar ratio 1/0.3/0.7)

A line corresponding to nitriles is not observed in the PA 1 and PA 2 products before aging. In order to simulate the thermo- or photo-oxidative aging of the PAs during their life, aging in an oven at 140° C. under air for 72 h was carried out on the PAs. This aging is representative of the degree of oxidation measured on PAs at the end of their life or which have been employed several times.

After aging, the molar ratio of the nitrile functions, with respect to the secondary amides, is 0.014 and 0.031 in PA 1 and PA 2 respectively.

The aged PAs according to the invention, EI 1 and EI 2, were subsequently formulated with 0.7% by weight of heat stabilizer (0.5% of Lowinox 44B25 (SI Group) and 0.2% of Irgafos 168 (BASF)).

Formulation is carried out using an 18 mm twin-screw extruder at a throughput of 5 kg/h and a temperature of 300° C., in order to obtain granules for evaluating the properties obtained during the second life of the material.

The flow length in injection was measured on an injection-molding machine equipped with a spiral mold (spiral flow test) with the following parameters:
Temperature of the mold: 40° C.
Hold pressure of the material: 900 bar
Temperature profile for PA 1: 230/250° C.
Temperature profile for PA 2: 270/290° C.
Flow rate: 57 cm³/s
Cooling time: 20 s

The test is carried out by injecting the molten polymer through the central core which directly feeds the spiral with a width of 20 mm and a thickness of 2 mm and having a maximum length of 1280 mm. There is a space of 10 mm between the channel walls of the spiral. The spiral mold is mirror polished.

The flow length values given in the table below correspond to the mean of the ten tests carried out for each sample.

This measurement makes it possible to characterize the processability of the compositions.

The elongation at break and the breaking stress were measured at 23° C. according to the standard ISO 527-1:2012 on dumbbells of type 1A on dry samples.

The dumbbells of type 1A were produced by injection molding for the tensile tests. The following parameters were used:
Engel Victory 500, 160T, hydraulic press
Injection temperature (feed/nozzle): 230° C./250° C. for PA 1 and 270° C./290° C. for PA 2
Temperature of the mold: 40° C.
Hold time: 20 s
Hold pressure of the material: 622 bar
Cooling time: 15 s

### Flow Length

This measurement makes it possible to characterize in particular the processability of the compositions.

TABLE 1

| | EC 1- | | EC 2- | |
|---|---|---|---|---|
| | virgin | EI 1-aged and | virgin | EI 2-aged and |
| Reference | PA 1 | reformulated PA 1 | PA 2 | reformulated PA 2 |
| Flow length | 132.2 | 370.5 | 135.9 | 158.2 |
| (mm) | | | | |

The compositions EI 1 and EI 2 according to the invention exhibit a flow length which is significantly greater than that of the comparative compositions EC 1 and EC 2.

This means that the compositions EI 1 and EI 2 according to the invention exhibit a better processability than the comparative compositions EC 1 and EC 2.

In particular, it will advantageously be possible to inject finer parts and/or parts with a better definition using a composition EI 1 or EI 2 according to the invention.

### Tensile Test According to ISO 527 1A at 23° C.

This measurement makes it possible to characterize the mechanical properties of the compositions.

TABLE 2

| | EC 1- | EI 1-aged and | EC 2- | EI 2-aged and |
|---|---|---|---|---|
| | virgin | reformulated PA | virgin | reformulated PA |
| Reference | PA 1 | 1 | PA 2 | 2 |
| Elongation at | 134.8 | 183.2 | 75.4 | 62.4 |
| break in % | | | | |
| Breaking | 57.28 | 65.22 | 52.3 | 54.9 |
| stress in MPa | | | | |

The composition EI 1 according to the invention exhibits a breaking stress and an elongation at break which are significantly greater than those of the comparative composition EC 1.

The composition EI 2 according to the invention exhibits a breaking stress which is significantly greater than that of the comparative composition EC 2. The elongation at break is slightly lower.

This means that the compositions EI 1 and EI 2 according to the invention will be more durable than the compositions EC 1 and EC 2. This is because it will be necessary to apply a greater strain and a greater stress to the composition EI 1 to cause it to break.

The compositions of the invention thus exhibit better mechanical properties, in particular in tension. The compositions according to the invention make it possible to obtain a new compromise between the processability and the mechanical properties.

1. A composition comprising at least:
(a) from 30% to 99.9% by weight of at least one recycled polyamide exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
with said polyamide being a polyamide of formula XY or A/XY in which:
A is an aliphatic repeat unit chosen from a unit obtained from the polycondensation of at least one amino acid, a unit obtained from the polycondensation of at least one lactam and a unit obtained from the polycondensation of at least one aliphatic diamine and of at least one aliphatic diacid,
X is at least one aliphatic or cycloaliphatic diamine, or one arylaliphatic or aromatic diamine, or a mixture of these, and
Y is at least one dicarboxylic acid, said diacid being chosen from a linear or branched aliphatic diacid, a cycloaliphatic diacid and an aromatic diacid, or a mixture of these, said diamine and said diacid comprising from 4 to 48 carbon atoms, advantageously from 6 to 18 carbon atoms,
with at least one of X and/or Y being cycloaliphatic, arylaliphatic or aromatic,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer,
(f) from 0% to 30% by weight of at least one impact modifier.

2. The composition as claimed in claim 1, wherein said molar ratio of the functions resulting from oxidation reactions, with respect to the secondary amide functions, is of between 0.0005 and 0.3.

3. The composition as claimed in claim 1, wherein said molar ratio of the imide functions, with respect to the secondary amide functions, is of between 0.0005 and 0.1.

4. The composition as claimed in claim 1, wherein said molar ratio of the carboxylic acid functions, with respect to the secondary amide functions, is of between 0.0005 and 0.1.

5. The composition as claimed in claim 1, wherein said molar ratio of the benzamide functions, with respect to the secondary amide functions, is of between 0.0005 and 0.1.

6. The composition as claimed in claim 1, wherein said molar ratio of the primary amide functions, with respect to the secondary amide functions, is of between 0.0005 and 0.1.

7. The composition as claimed in claim 1, wherein said molar ratio of the nitrile functions, with respect to the secondary amide functions, is of between 0.0005 and 0.1.

8. The composition as claimed in claim 1, wherein said molar ratio of the chain-end methyl functions, with respect to the secondary amide functions, is of between 0.0005 and 0.2.

9. The composition as claimed in claim 1, wherein said molar ratio of the alkene functions, with respect to the secondary amide functions, is of between 0.0005 and 0.1.

10. The composition as claimed in claim 1, wherein said molar ratio of the formamide functions, with respect to the secondary amide functions, is of between 0.0005 and 0.1.

11. The composition as claimed in claim 1, comprising:
(a) from 30% to 99.9% by weight of at least one recycled polyamide of formula XY or A/XY as defined above and exhibiting functions resulting from oxidation reactions chosen from benzamide functions, nitriles, primary amides, chain-end methyl groups, alkenes, formamides, imides, carboxylic acids and their mixtures in a molar ratio, with respect to the secondary amide functions, which is greater than that of the same virgin polyamide,
(b) from 0.1% to 10% by weight of at least one additive,
(c) from 0% to 70% by weight of at least one virgin polyamide,
(d) from 0% to 65% by weight of at least one filler,
(e) from 0% to 15% by weight of at least one plasticizer, and
(f) from 0% to 30% by weight of at least one impact modifier,
the sum of the constituents (a)-(f) being equal to 100%.

12. The composition as claimed in claim 1, wherein said polyamide of formula XY or A/XY has a C/N ratio of greater than 6.5.

13. The composition as claimed in claim 1, wherein said polyamide of formula XY or A/XY is chosen from polyamides of formula XT, A/XT, PY, APY, BY or A/BY with B being BMACM or MACM, P being PACM.

14. The composition as claimed in claim 1, wherein said polyamide of formula XY or A/XY is chosen from PA 6T, PA 9T, PA 10T, PA 12T, PA 14T, PA 16T, PA MPMDT/6T, PA11/10T, PA 5T/10T, PA 11/BACT, PA 11/6T/10T, PA MXDT/10T, PA MPMDT/10T, PA BACT/10T, PA BACT/6T, PA BACT/10T/6T, PA 11/BACT/6T, PA 11/MPMDT/6T, PA 11/MPMDT/10T, PA 11/BACT/10T, PA 11/MXDT/10T, PA11/5T/10T, PA11/B10, PA12/B10, PA11/P10, PA12/P10, PA11/BI/BT, PA12/BI/BT, PA11/PI/BT, PA12/PI/BT, PA11/PI/PT, PA12/PI/PT, PA11/BI, PA12/BI, PA11/PI, PA12/PI, PA1010/B10, PAB12, PAP12, PAP10, PAMXD6, PAMXD10 and PAMXD12 and their mixtures.

15. The composition as claimed in claim 1, wherein it comprises from 0.1% to 50% by weight of at least one virgin polyamide, with respect to the total weight of the composition.

16. The composition as claimed in claim 1, wherein said additive is chosen from a catalyst, an antioxidant, a heat stabilizer, a UV absorber, a light stabilizer, a lubricant, a nucleating agent, a colorant, a wax and their mixtures.

17. The composition as claimed in claim 1, wherein it is provided in the form of solid particles with a median diameter D50 of less than 20 mm.

18. A method comprising using from 30% to 99.9% by weight of at least one recycled polyamide of formula XY or A/XY in a composition as defined according to claim 1, for conferring, on said composition, a greater flow length in injection, in comparison with one and the same composition in which the polyamide of formula XY or A/XY is nonrecycled.

19. A method comprising using a composition as claimed in claim 1 in the manufacture of objects.

20. An object consisting of at least 30% by weight of a composition as defined according to claim 1.

21. A process for the manufacture of an object employing solid particles as defined in claim 17, by remelting said particles and then shaping an object by extrusion, molding or blowing of the melted particles.

22. An object capable of being obtained by the process of claim 21.

23. The object as claimed in claim 22, wherein an extruded, molded or blown part, a composite comprising continuous fibers, a film, a fiber, a yarn or a filament is concerned.

24. A process for the manufacture of a composition as defined according to claim 1, comprising at least the following stages:
a) having available post-industrial waste and/or post-consumer waste,
b) grinding said post-industrial waste and/or said post-consumer waste,
c) optionally, carrying out a granulation of the ground material obtained on conclusion of stage b),
d) preparing said composition.
